(19) United States
(12) Patent Application Publication
(10) Pub. No.: US 2015/0063462 A1
(43) Pub. Date: Mar. 5, 2015

(54) METHOD AND SYSTEM FOR ENHANCING THE QUALITY OF VIDEO DURING VIDEO COMPRESSION

(71) Applicant: CRISPIFY SOFTWARE PRIVATE LIMITED, Bangalore (IN)

(72) Inventor: Lakshmanan BALARAMAN, Bangalore (IN)

(73) Assignee: CRISPIFY SOFTWARE PRIVATE LIMITED, Bangalore (IN)

(21) Appl. No.: 14/065,397

(22) Filed: Oct. 28, 2013

(30) Foreign Application Priority Data
Aug. 29, 2013 (IN) 3852/CHE/2013

(51) Int. Cl. H04N 19/86

(52) U.S. Cl. CPC H04N 19/00909
USPC 375/240.24

(57) ABSTRACT

The present invention provides a method and system for compressing video data of a video input. The method and the system include selecting a first frame from a plurality of frames of the video data of the video input, performing a macroblock by macroblock comparison of the selected first frame with a second frame of the plurality of frames of the video data to fetch a delta value, comparing the delta value with a pre-determined threshold and checking a pre-determined jerk balancing condition and skipping the second frame based on the comparison of the delta value of the selected first frame of the plurality of frames with the pre-determined threshold and the pre-determined jerk balancing condition. The second frame is followed by the first frame in the video inputs.

This application claims priority to Indian Application Serial No. 3852/CHE/2013 filed Aug. 29, 2013, the contents of which are hereby incorporated by reference.

### TECHNICAL FIELD

The present technology generally relates to methods and systems for video compression, and more particularly, relates to methods and systems for enhancing the quality of video during video compression.

### BACKGROUND

Nowadays, there are several known video compression standards and approaches for processing and displaying video streams. Some of these industry standards include but not limited to MPEG, H.264, WMV, VP8 and the like. In some of these commonly known industry standards and approaches, image data or image content is compressed in small blocks with a constant frame rate. In these approaches, embedded video compression supports random data access within a video frame. In other words, embedded video compression is transparent to the video processing units. These approaches or technique saves memory footprint and bandwidth. In some other approaches or standards, a delta pulse code modulation (DPCM) and/or Golomb coding based approach is used.

However, there are some disadvantages of the conventional approaches. For examples, issues occur if the data to be compressed comprises graphic data besides the regular video data. For instance, the graphic data or graphic content can be generated by a computer. In this case, visible artifacts can be spotted even with the same compression data rate. This reduces the video quality significantly, since normally the controller does not comprise knowledge about the kind of input image data, like video content or graphic content.

Further, these approaches do not automate the enhancement process. Furthermore, these compression approaches do not improve the quality of the video temporally. In light of the above discussion, there is a need for a compression technique which enhances the quality of the video. In addition, the compression technique should improve the tempo of the video by removing the inconsistencies in the video. Further, it should help the users without expertise in video enhancement to share enhanced videos easily over the internet.

### SUMMARY OF THE INVENTION

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

The present invention provides a method and system for compressing video data of a video input. The method and the system include selecting a first frame from a plurality of frames of the video data of the video input, performing a macroblock by macroblock comparison of the selected first frame with a second frame of the plurality of frames of the video data to fetch a delta value, comparing the delta value with a pre-determined threshold and a pre-determined jerk balancing condition and skipping the second frame based on the comparison of the delta value with the pre-determined threshold and the pre-determined jerk balancing condition. The second frame is followed by the first frame in the video inputs.

In an embodiment, the macroblock by macroblock comparison of the selected first frame of the plurality of frames of the video data of the video inputs with the second frame of the plurality of frames of the video data of the video input includes calculating sum of absolute differences in pixel values between the macro blocks of the selected first frame and the selected second frame. In an embodiment, the method includes initializing a counter to a pre-determined number to check maximum number of continuous skip frames from the plurality of frames of the video data of the video input. The counter for the pre-determined number is continually decreased based on number of continuous skip frames from the plurality of frames of the video data of the video input. The counter is re-adjusted to the pre-determined number when the counter is decreased below a minimum threshold number. The pre-determined number is set by an administrator. The pre-determined threshold and the pre-determined jerk balancing condition are based on a size of the object in motion in the video data of the video input.

In another aspect of the invention, the frame control system for compressing video data of a video input is provided. The frame control system includes a selection module configured to select a first frame from a plurality of frames of the video data of the video input, a comparison module configured to perform a macroblock by macroblock comparison of the selected first frame of the plurality of frames of the video data of the video inputs with a second frame of the plurality of frames of the video data of the video inputs to fetch a delta value, comparing the delta value with a pre-determined threshold and also checking a pre-determined jerk balancing condition and a skipping module configured to skip the second frame of the plurality of frames based on the comparison of the delta value with the pre-determined threshold and checking the pre-determined jerk balancing condition.

In an embodiment, the comparison module is further configured to perform macroblock by macroblock comparison of the selected first frame of the plurality of frames of the video data of the video inputs with the second frame of the plurality of frames of the video data of the video input by calculating sum of absolute differences in pixel values between the macro blocks of the selected first frame and the selected second frame.

In an embodiment, the counter initializes a pre-determined number to check maximum number of continuous skip frames from the plurality of frames of the video data of the video input. The counter is adapted to continually decrease the pre-determined number based on number of continuous skip frames from the plurality of frames of the video data of the video input. The counter is re-adjusted to the pre-determined number when the counter is decreased below a minimum threshold number. The pre-determined number is set by an administrator.

In yet another aspect of the invention, a computer system for compressing video data of a video input is provided. The computer system includes one or more processors having a frame control module and a non-transitory memory containing instructions that, when executed by the one or more processors, causes the frame control module of the one or more processors to perform a set of steps. The set of steps include selecting a first frame from a plurality of frames of the video data of the video input by a selection module of the frame control module, performing macroblock by macroblock comparison of the selected first frame of the plurality of frames of the video data of the video inputs with a second frame of the plurality of frames of the video data of the video inputs to fetch a delta value and comparing the delta value with a pre-determined threshold and checking a pre-determined jerk balancing condition by a comparison module of the frame control module, and skipping the second frame of the plurality of frames based on the comparison of the delta value with the pre-determined threshold by a skipping module of the frame control module.

In an embodiment, the skipping module of the frame control module skips the second frame of the plurality of frames based on the pre-determined jerk balancing condition.

In an embodiment, the comparison module is further configured to perform macroblock by macroblock comparison of the selected first frame of the plurality of frames of the video data of the video inputs with the second frame of the plurality of frames of the video data of the video input by calculating sum of absolute differences in pixel values between the macro blocks of the selected first frame and the selected second frame.

In an embodiment, the counter initializes a pre-determined number to check maximum number of continuous skip frames from the plurality of frames of the video data of the video input. The counter is adapted to continually decrease the pre-determined number based on number of continuous skip frames from the plurality of frames of the video data of the video input. The counter is re-adjusted to the pre-determined number when the counter is decreased below a minimum threshold number. The pre-determined number is set by an administrator.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates various components of a portable computing device in which various embodiments of the present invention are practiced;

FIG. 2 illustrates feeding of the various video inputs for processing in accordance with various embodiments of the present invention;

FIG. 3A illustrates an exemplary sequence of low motion frames in accordance with various embodiments of the present invention;

FIG. 3B illustrates an exemplary sequence of low motion and high motion frames in accordance with various embodiments of the present invention;

FIG. 4A illustrates an exemplary detection of low motion frames in accordance with various embodiments of the present invention;

FIG. 4B illustrates an exemplary detection of high motion frames in accordance with various embodiments of the present invention;

FIG. 5A illustrates a 16×16 macroblock having four 8×8 blocks and sixteen 4×4 sub-blocks, in accordance with various embodiments of the present invention;

FIG. 5B illustrates two similar macro blocks (only part of it is shown, assume all other pixels are same in both the macroblocks) having delta value 1, in accordance with various embodiments of the present invention;

FIG. 6 illustrates a block diagram of a frame control module, in accordance with various embodiments of the present invention; and

FIG. 7 illustrates a flow chart for compressing video data of a video input, in accordance with various embodiments of the present invention.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

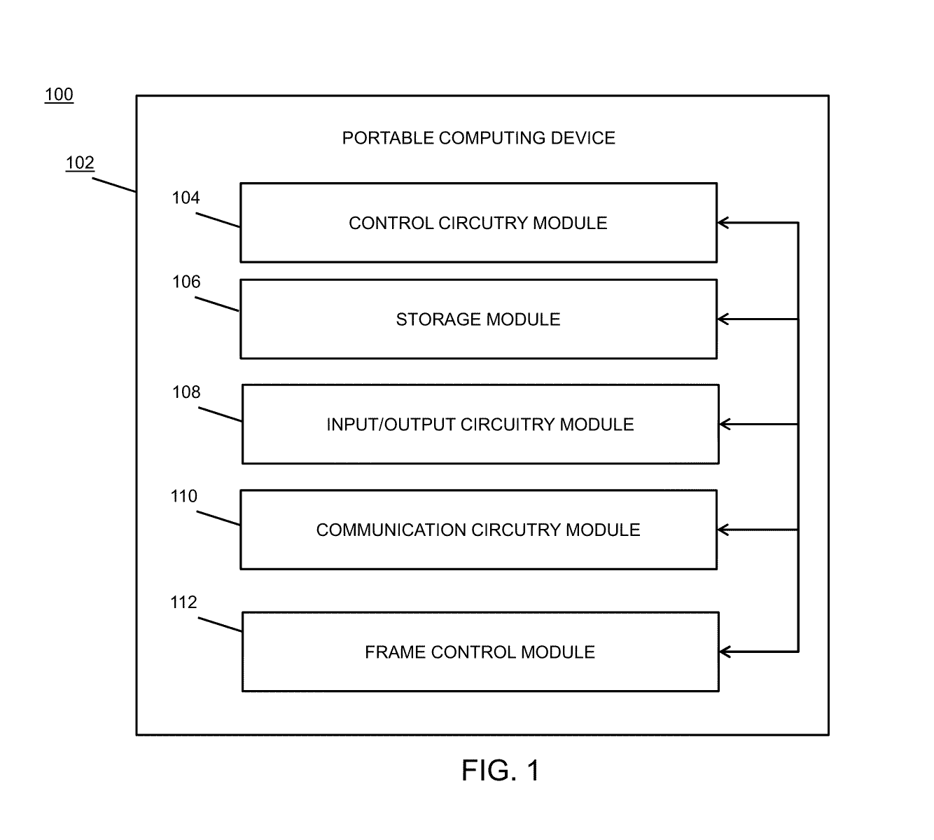

FIG. 1 illustrates a block diagram 100 of a portable computing device 102, in accordance with various embodiments of the present invention. As shown in FIG. 1, the portable computing device 102 includes a control circuitry module 104, a storage module 106, an input/output (“I/O”) circuitry module 108, a communication circuitry module 110, and a frame control module 112.

Those skilled in the art would appreciate that the portable computing device 102 of FIG. 1 may include one or more components which may not be shown here. These one or more components of the portable computing device 102 may be combined or omitted with the components shown in FIG. 1. The portable computing device 102 includes any suitable type of electronic device. Examples of the portable computing device 102 include but may not be limited to a digital media player (e.g., an iPod™ made available by Apple Inc. of Cupertino, Calif.), a personal e-mail device (e.g., a Blackberry™ made available by Research in Motion of Waterloo, Ontario), a personal data assistant (“PDA”), a cellular telephone, a Smartphone, a handheld gaining device, a digital camera, a laptop computer, and a tablet computer. In another embodiment of the present invention, the portable computing device 102 can be a desktop computer.

From the perspective of this invention, the control circuitry module 104 includes any processing circuitry or processor operative to control the operations and performance of the portable computing device 102. For example, the control circuitry module 104 may be used to run operating system applications, firmware applications, media playback applications, media editing applications, or any other application. In an embodiment, the control circuitry module 104 drives a display and process inputs received from a user interface.

From the perspective of this invention, the storage module 106 includes one or more storage mediums including a hard-drive, solid state drive, flash memory, permanent memory such as ROM, any other suitable type of storage component, or any combination thereof. The storage module 106 may store, for example, media data (e.g., music and video files), application data (e.g., for implementing functions on the portable computing device 102).

From the perspective of this invention, the I/O circuitry module 108 may be operative to convert (and encode/decode, if necessary) analog signals and other signals into digital data. In an embodiment, the I/O circuitry module 108 may also convert digital data into any other type of signal, and vice-versa. For example, the I/O circuitry module 108 may receive and convert physical contact inputs (e.g., from a multi-touch screen), physical movements (e.g., from a mouse or sensor), analog audio signals (e.g. from a microphone), or any other input. The digital data may be provided to and received from the control circuitry module 104, the storage module 106, or any other component of the portable computing device 102.

It may be noted that the I/O circuitry module 108 is illustrated in FIG. 1 as a single component of the portable computing device 102; however those skilled in the art would appreciate that several instances of the I/O circuitry module 108 may be included in the portable computing device 102.

The portable computing device 102 may include any suitable interface or component for allowing a user to provide inputs to the I/O circuitry module 108. The portable computing device 102 may include any suitable input mechanism. Examples of the input mechanism include but may not be limited to a button, keypad, dial, a click wheel, and a touch screen. In an embodiment, the portable computing device 102 may include a capacitive sensing mechanism, or a multi-touch capacitive sensing mechanism.

In an embodiment, the portable computing device 102 may include specialized output circuitry associated with output devices such as, for example, one or more audio outputs. The audio output may include one or more speakers built into the portable computing device 102, or an audio component that may be remotely coupled to the portable computing device 102.

The one or more speakers can be mono speakers, stereo speakers, or a combination of both. The audio component can be a headset, headphones or ear buds that may be coupled to communications device with a wire or wirelessly.

In an embodiment, the I/O circuitry module 108 may include display circuitry for providing a display visible to the user. For example, the display circuitry may include a screen (e.g., an LCD screen) that is incorporated in the portable computing device 102.

The display circuitry may include a movable display or a projecting system for providing a display of content on a surface remote from the portable computing device 102 (e.g., a video projector). In an embodiment, the display circuitry may include a coder/decoder to convert digital media data into analog signals. For example, the display circuitry may include video Codecs, audio Codecs, and/or any other suitable type of Codec.

The display circuitry may include display driver circuitry, circuitry for driving display drivers, or both. The display circuitry may be operative to display content. The display content can include media playback information, application screens for applications implemented on the electronic device, information regarding ongoing communications operations, information regarding incoming communications requests, or device operation screens under the direction of the control circuitry module 104. Alternatively, the display circuitry may be operative to provide instructions to a remote display.

In addition, the portable computing device 102 includes the communications circuitry module 110. The communications circuitry module 110 may include any suitable communications circuitry operative to connect to a communications network and to transmit communications (e.g. voice or data) from the portable computing device 102 to other devices within the communications network. The communications circuitry 110 may be operative to interface with the communications network using any suitable communications protocol. Examples of the communications protocol include but may not be limited to Wi-Fi, Bluetooth®, radio frequency systems, infrared, LTE, GSM, GSM plus EDGE, CDMA, and quad band.

In an embodiment, the communications circuitry module 110 may be operative to create a communications network using any suitable communications protocol. For example, the communications circuitry module 110 may create a short-range communications network using a short-range communications protocol to connect to other devices. For example, the communications circuitry module 110 may be operative to create a local communications network using the Bluetooth® protocol to couple the portable computing device 102 with a Bluetooth® headset.

It may be noted that the computing device is shown to have only one communication operation; however, those skilled in the art would appreciate that the portable computing device 102 may include one more instances of the communications circuitry module 110 for simultaneously performing several communications operations using different communications networks. For example, the portable computing device 102 may include a first instance of the communications circuitry module 110 for communicating over a cellular network, and a second instance of the communications circuitry module 110 for communicating over Wi-Fi or using Bluetooth®.

In an embodiment, the same instance of the communications circuitry module 110 may be operative to provide for communications over several communications networks. In an embodiment, the portable computing device 102 may be coupled a host device for data transfers, synching the communications device, software or firmware updates, providing performance information to a remote source (e.g., providing riding characteristics to a remote server) or performing any other suitable operation that may require the portable computing device 102 to be coupled to a host device. Several computing devices may be coupled to a single host device using the host device as a server. Alternatively or additionally, the portable computing device 102 may be coupled to several host devices (e.g., for each of the plurality of the host devices to serve as a backup for data stored in the portable computing device 102).

From the perspective of this invention, the portable communication device 102 includes the frame control module 112. The frame control module 112 in conjunction with other modules which include but may not be limited to the control circuitry module 104, the storage module 106, the input/output (“I/O”) circuitry module 108, and the communication circuitry module 110 provides a compression approach (herein after “the present invention”) for videos which solves the bandwidth limitation for uploading and sharing the videos on internet. In addition, the present invention enhances the quality of the video. Further, the present invention helps the users without expertise in video enhancement to share enhanced videos easily over the internet. In addition, the present invention helps the VVOIP calls if it is implemented before the encoder step in a multimedia pipeline. Furthermore, the present invention is implemented as a pre-processing step (i.e. by feeding raw video frames before encoding while recording the video itself) as well as video post-processing step. In an embodiment, if the present invention is implemented while recording a video itself, the storage of videos in recording devices becomes easy as the file size is reduced to a large extent. Furthermore, the present invention automatically enhances the tempo of the video, thereby removing the inconsistencies in the video that a person without much knowledge on video editing cannot resolve. In other words, the present invention enables the production of high quality video by automating the enhancement process.

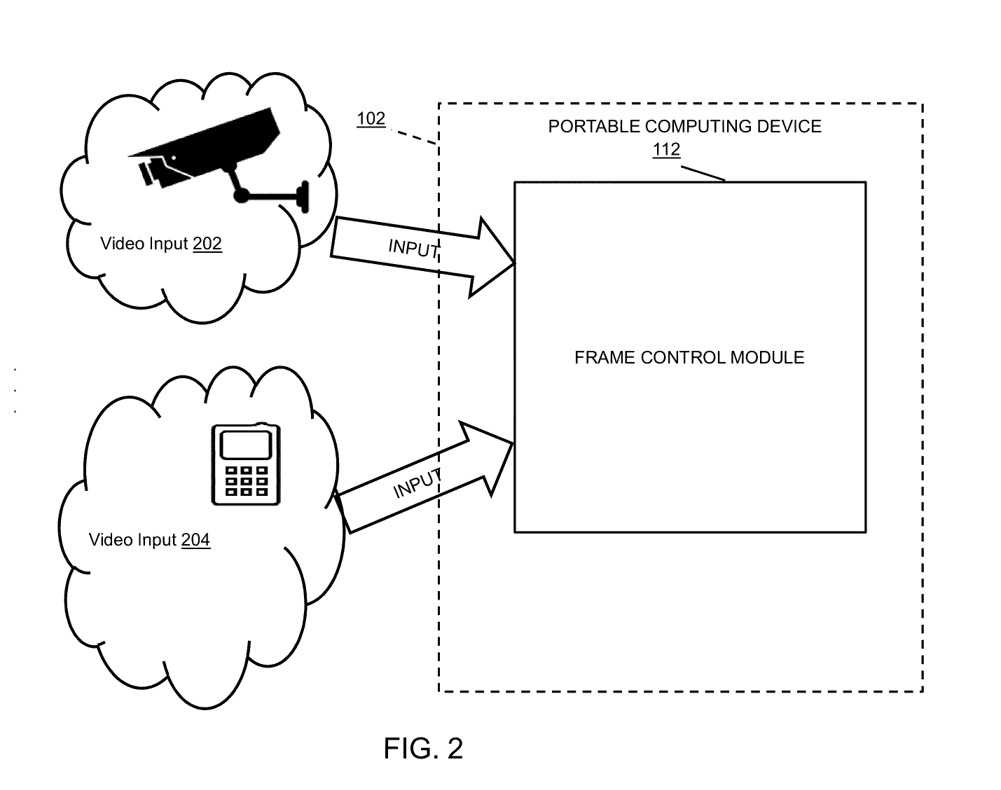

For example, referring to FIG. 2, a video input 202 from a recording surveillance camera may be fed in the frame control module 112 of the portable computing device 102. Similarly, a video input 204 from a mobile phone may be fed in the frame control module 112 of the portable computing device 102. The frame control module 112 processes the video input 202 and the video input 204 and provides an enhanced video output with decreased size for both the video input 202 and the video input 204. In general, the frame control module 112 takes video from any video recording or storage devices such as digital camera, mobile phone, camcorder, laptop computers, handheld gadgets etc., as an input and gives tempo enhanced and file size compressed video output which can be stored or shared on any medium which supports streaming of video such as internet mobile device, handheld devices, computers etc.

In an embodiment, the frame control module 112 is present in the mobile device itself. In other words, the frame control module 112 is an integral part of the video input device (say input device for the video input 202 or input device for video input 204) itself and provides an enhanced video with reduced size without using the portable computing device 102.

It may be noted that FIG. 2 has been shown to include the video input 202 and the video input 204; however, those skilled in the art would appreciate that the frame control module 112 can process a plurality of video inputs simultaneously or independently.

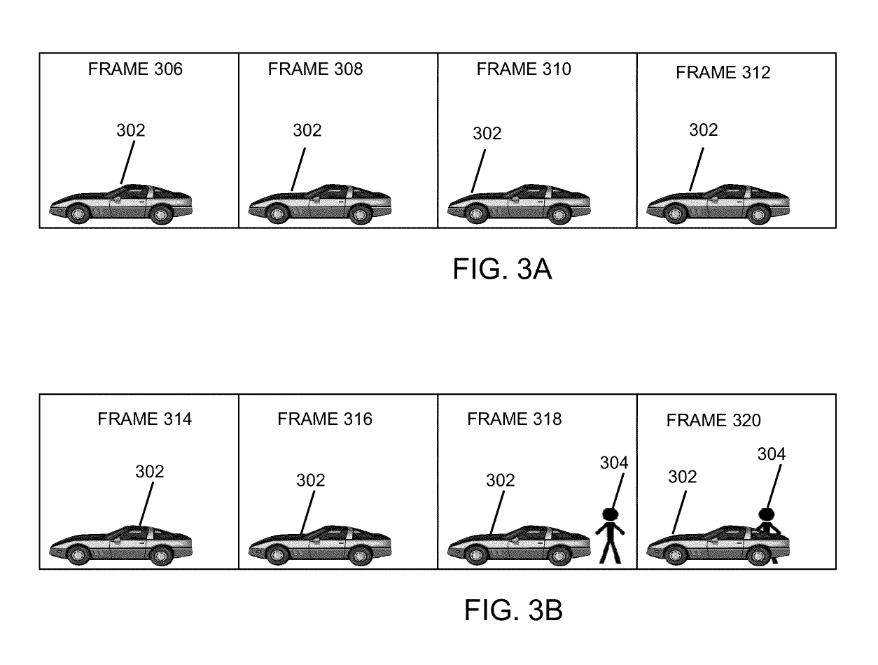

In an embodiment, the frame control module 112 processes the video input 202 and/or the video input 204 using variable frame rate. The number of frames displayed per second is usually constant for any video. For example, the video input 202 may have 25 frames per second (hereinafter ‘fps’) and/or the video input 204 may have 30 fps. The frame control module 112 of the present invention enables variable displays of the frames. In an embodiment, the frame control module 112 skips certain frames and displays certain frames. In an embodiment, the frame control module 112 identifies and skips low motion frames. For example, a user may be recording a video at 30 fps. In an embodiment, if the frame control module 112 skips 3 frames in the first set 30 frames in a group of pictures, then first second of video is displayed at 27 fps. Accordingly, for the next 30 frames, if 5 frames are skipped, then the next second of video is displayed at 25 fps. In an embodiment, the frame control module 112 achieves more compression and uniform tempo while encoding the video (say the video input 202 or the video input 204) itself before storing the video. For illustrative purpose and in accordance with various embodiments of the present invention, an exemplary sequence of low motion frames is shown in FIG. 3A. The low motion frames include frame 306, frame 308, frame 310 and frame 312.

Similarly, for illustrative purpose and in accordance with various embodiments of the present invention, an exemplary sequence of the low motion frames (a frame 314 and frame 316 where a vehicle 302 is stationary) and high motion frames is shown in FIG. 3B where the vehicle 302 is stationary but a person 304 is moving towards the vehicle 302 (a frame 318 and frame 320).

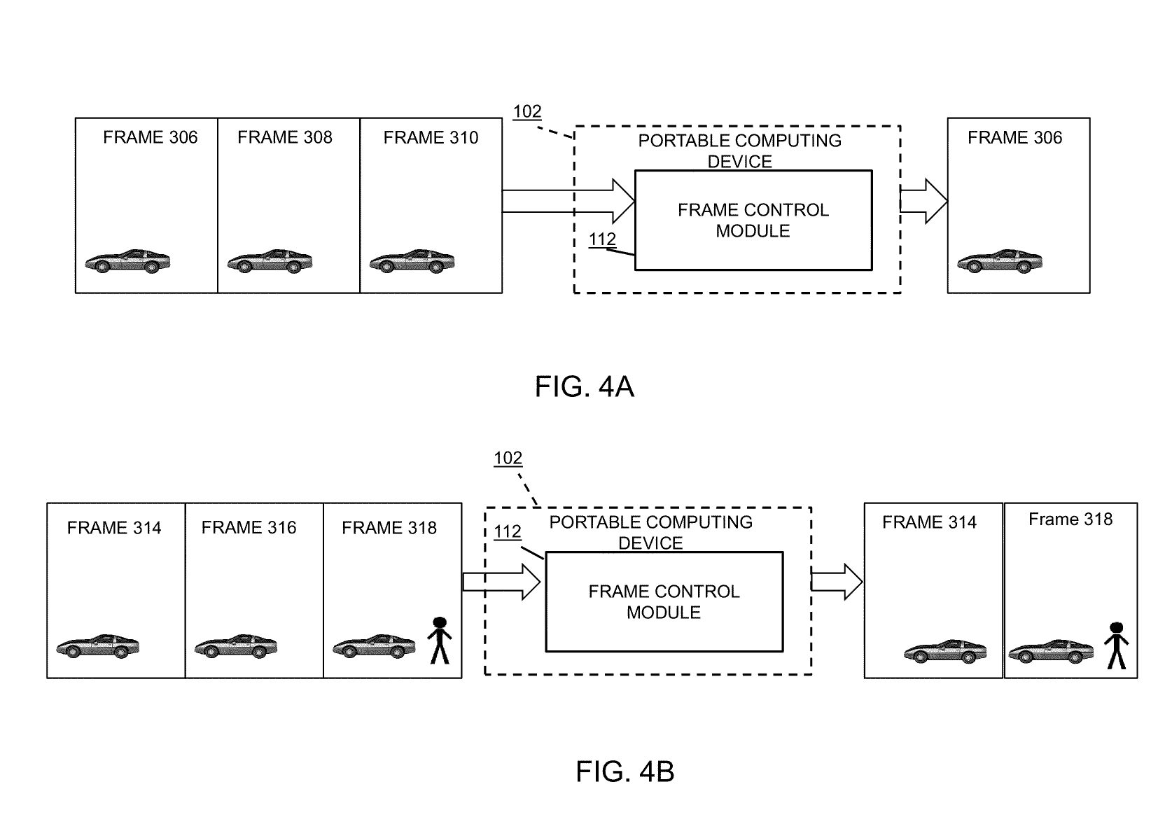

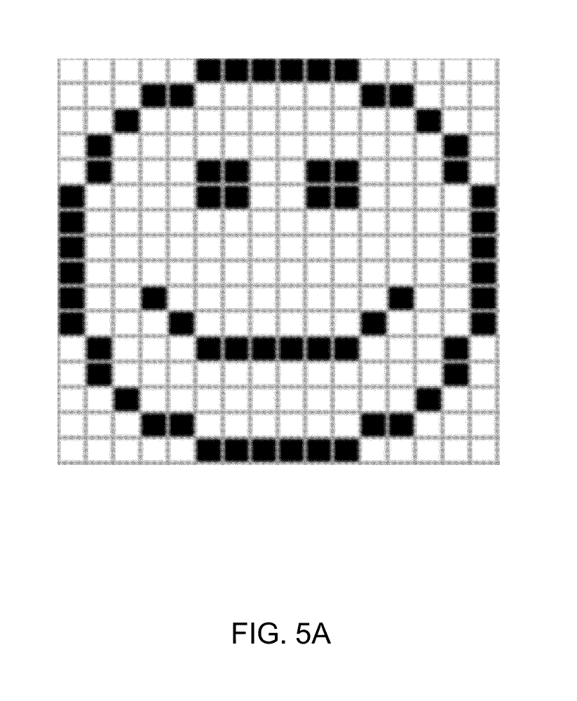

As illustrated in FIG. 4A, when the low motion frames 306, 308 and 310 are passed through the frame control module 112, the frame control module 112 skips the frames 308 and 310. As illustrated in FIG. 4B, when the frames 314 and 316 are passed through the frame control module 112, the frame control module 112 skips the frame 316. In an embodiment, the frame control module 112 can process the video which needs to be only displayed (not stored) while recording. In an embodiment, the frame control module 112 can process the video as a pre-processing step. In another embodiment, the frame control module 112 can process the video as a post-processing step. In yet another embodiment, the frame control module 112 can process the video as an encoding step. The frame control module 112 can be used for processing user generated videos, surveillance videos, VVOIP calls, live video streaming, and the like.

In an embodiment, the frame control module 112 performs certain method steps which analyses each and every frame of the raw input video (say the video input 202 and/or the video input 204) and determines whether that particular frame is below or above the threshold of high motion video. In an embodiment, in one of the method steps, raw frames of the video input (say the video input 202 and video input 204) are fed in the frame control module 112 before encoding. In another embodiment, for the already encoded and stored videos, firstly, the frame control module 112 decodes the videos. Secondly, each raw frame is compared to previous raw frame macroblock by macroblock. A Macroblock in context of the present invention and technology known in the art is a 16×16 pixel block inside a video frame. For example, if the resolution of the video is 480×320, then each frame of that video will have 30×20 macroblocks. Thirdly, the sum of absolute differences in pixel values between the co-located macroblocks in neighboring frames is calculated. This value is denoted by ‘delta’. It may be noted that in context of the present invention, the macroblocks are denoted hereinafter as ‘MBs’. Similarly, it may be noted that in context of the present invention, the MBs which has delta value as zero are called ‘skip MBs’. On the same lines, the MBs which has delta value less than or equal to 5 but are not ‘skip MBs’ are called ‘Delta5 MBs’. The MBs which has delta value less than or equal to 10 but are not ‘skip MBs’ or ‘Delta5 MBs’ are called ‘Delta10 MBs’. In an embodiment, if the video frame contains more than or equal to 10% of ‘skip MBs’ and more than or equal to 5% of ‘Delta5 MBs’ and more than or equal to 2% of ‘Delta10 MBs’ of the total MBs in that frame, then the frame is considered to be the low motion video frame and that particular frame is skipped before encoding. Otherwise, the frame may either have more than 40% of ‘Skip MBs’ or 30% of ‘Skip MBs’ and 10% of ‘Delta5 MBs’ to be considered as low motion video frame. Those skilled in the art would appreciate that the percentages provided above may vary and can be tuned for different videos based on the size of object in motion.

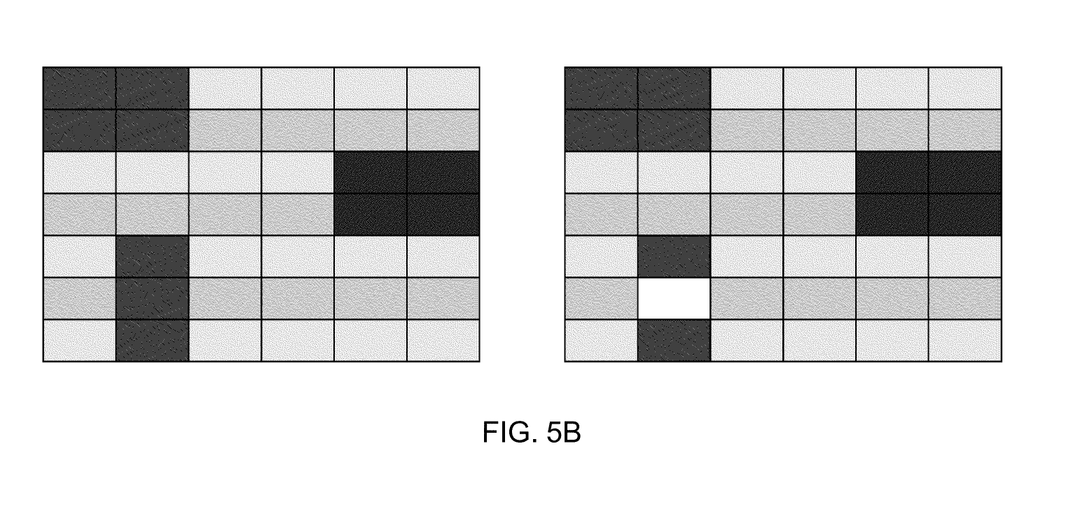

To explain the concept of delta and MBs pictorially, FIG. 5A illustrates a frame of 16×16 pixels, in accordance with various embodiments of the present invention and FIG. 5B illustrates two similar macro blocks (only a part of it is shown, assume other pixels in both the macroblocks are same), having delta value 1 (due to one different pixel), in accordance with various embodiments of the present invention. In an embodiment, the frame control module 112 may not allow to continuously skip many frames. This ensures that smoothness of the videos is maintained. In this embodiment, a counter to check maximum number of continuous skip frames is initialized as 4. In other words, at first, the frame control module 112 continuously skips 4 frames. The 5th frame may not be skipped even though if the 5th frame has to be skipped according to the method steps. Once 4 frames are continuously skipped, the counter is reduced to 3. After that, if 3 frames are continuously skipped, the next frame is not skipped even it is a low motion frame. After that, the counter is reduced to 2. After that only 2 frames can be continuously skipped. Counter may be reduced to 1 if 2 frames are skipped continuously. Then if 1 frame is skipped, the counter is set to 4 again. The above stated cycle continuously repeats, thereby maintaining the smoothness in the video and avoiding jerks in the video. In the context of the current invention, the whole process may be referred to as ‘criteria for avoiding jerks’. The counter which establishes the ‘criteria for avoiding jerks’ may be set by an administrator.

In various embodiments of the present invention, the frame control module 112 processes the video (say the video input 202 and/or the video input 204) following various process steps. It may be noted that the various process steps may be followed in a sequence or the sequence may be changed within the scope of the present invention. In addition, the process steps may include more or less number of steps that will enable to achieve the object of the present invention within the technological scope of the present invention.

In an aspect of the flow of the process steps of the present invention, the frame control module 112 performs macroblock comparison of a first frame and a second frame of the video input (say the video input 202 and/or the video input 204) to obtain delta values. Accordingly, the second frame is selected or eliminated based on the proportion of Delta MBs. If the proportion of Delta MBs is above a pre-defined threshold, the second frame is selected. If the proportion of Delta MBs is below a pre-defined threshold, the second frame is eliminated. Accordingly, other frames are selected and eliminated based on the values of delta and the comparisons.

In another aspect of the flow of the process steps of the present invention, the frame control module 112 performs macroblock comparison of a first frame and a second frame of the video input (say the video input 202 and/or the video input 204) to obtain delta values. In this aspect, the second frame is selected or eliminated not only on the values of delta but also on the pre-defined conditions laid for the jerks in the video (explained above in the application). Accordingly, other frames are selected and eliminated.

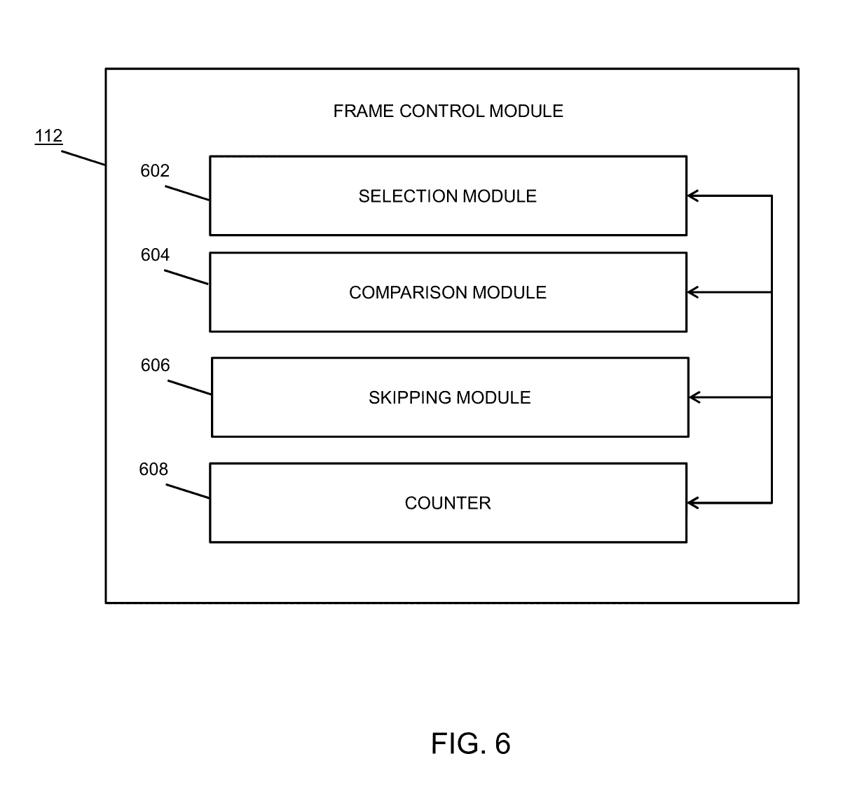

FIG. 6 illustrates a block diagram 600 of the frame control module 112 in accordance with various embodiments of the present invention. The frame control module 112 includes a selection module 602, a comparison module 604 and a skipping module 606. It may be noted that the frame control module 112 is shown to include the above stated components; however, those skilled in the art would appreciate that the frame control module 112 can have one or more components that can perform the functionality stated in the present invention. The selection module 602 of the frame control module 112 selects a first frame from a plurality of frames of the video data of the video input. The comparison module 604 performs a macroblock by macroblock comparison of the selected first frame of the plurality of frames of the video data of the video inputs with a second frame of the plurality of frames of the video data of the video input to fetch a delta value. As explained above, raw frames of the video input (say the video input 202 and the video input 204) are fed in the frame control module 112 before encoding. In another embodiment, for the already encoded and stored videos, firstly, the frame control module 112 decodes the videos. Secondly, each raw frame is compared to previous raw frame macroblock by macroblock. In an embodiment of the present invention, the comparison module 604 is configured to perform macroblock by macroblock comparison of the first frame of the plurality of frames of the video data of the video inputs with the second frame of the plurality of frames of the video data of the video input by calculating sum of absolute differences in pixel values between the macro blocks of the selected first frame and the selected second frame. This value is denoted by ‘delta’.

The comparison module 604 compares the delta value of the selected first frame of the plurality of frames of the video data of the video inputs with a pre-determined threshold and a pre-determined jerk balancing condition. Accordingly, the skipping module 606 skips the second frame of the plurality of frames based on the comparison of the delta value with the pre-determined threshold and the pre-determined jerk balancing condition. As mentioned above, in an embodiment, if the video frame contains more than or equal to 10% of ‘skip MBs’ and more than or equal to 5% of ‘Delta5 MBs’ and more than or equal to 2% of ‘Delta10 MBs’ of the total MBs in that frame, then the frame is considered to be the low motion video frame and that particular frame is skipped before encoding. Otherwise, the frame may either have more than 40% of ‘Skip MBs’ or 30% of ‘Skip MBs’ and 10% of ‘Delta5 MBs’ to be considered as low motion video frame. In an embodiment of the present invention, the frame control module 112 includes a counter 608.

In an embodiment, the counter 608 initializes a pre-determined number to check maximum number of continuous skip frames from the plurality of frames of the video data of the video input. In an embodiment of the present invention, the counter 608 is adapted to continually decrease the pre-determined number based on number of continuous skip frames from the plurality of frames of the video data of the video input. In an embodiment, the counter 608 is re-adjusted to the pre-determined number when the counter 608 is decreased below a minimum threshold number. As mentioned above, the counter 608 of the frame control module 112 may not allow to continuously skipping many frames. In this embodiment, the counter 608 to check maximum number of continuous skip frames is initialized as 4. In other words, at first, the frame control module 112 continuously skips 4 frames. The 5th frame may not be skipped even though if the 5th frame has to be skipped according to the method steps. Once 4 frames are continuously skipped, the counter 608 is reduced to 3. After that, if 3 frames are continuously skipped, the next frame is not skipped even it is a low motion frame. After that, the counter 608 is reduced to 2. After that only 2 frames can be continuously skipped. The Counter 608 may be reduced to 1 if 2 frames are skipped continuously. Then if 1 frame is skipped, the counter 608 is set to 4 again. The above stated cycle continuously repeats, thereby maintaining the smoothness in the video and avoiding jerks in the video. In the context of the current invention, the whole process may be referred to as ‘criteria for avoiding jerks’. The counter 608 which establishes the ‘criteria for avoiding jerks’ may be set by an administrator.

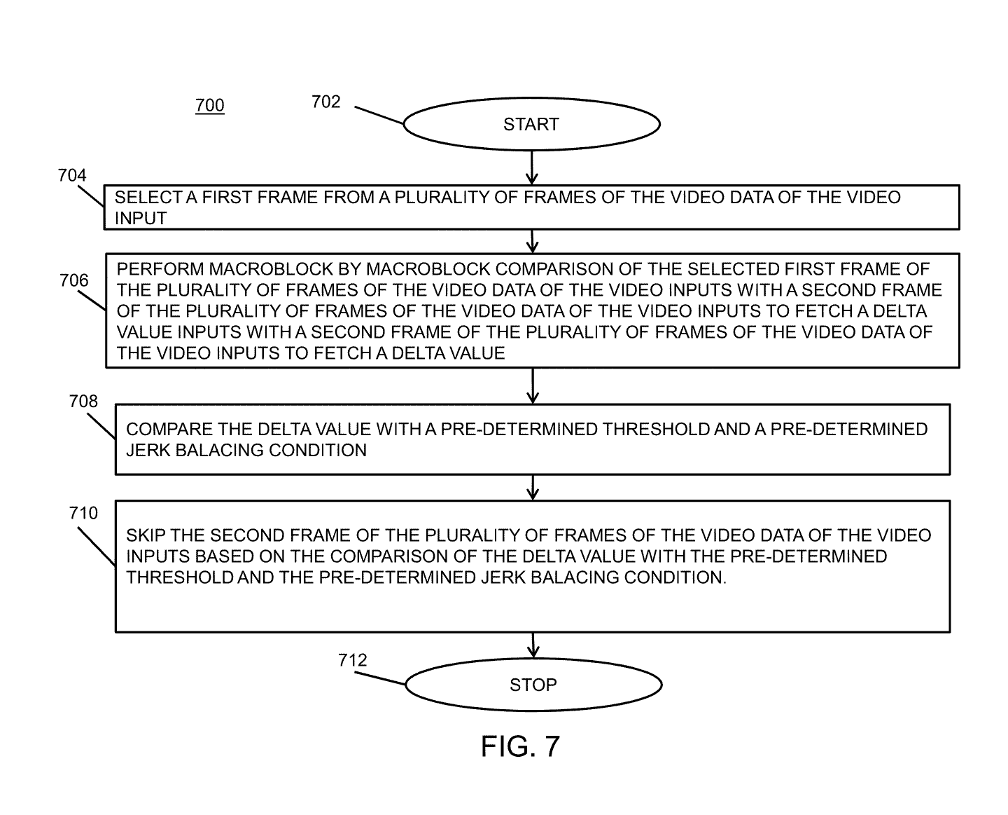

FIG. 7 illustrates a flow chart 700 for compressing video data of a video input, in accordance with various embodiments of the present invention. It may be noted that references will be made to FIG. 1, FIG. 2. FIG. 3, FIG. 4, FIG. 5 and FIG. 6 to explain the flow chart 700. In addition, it may be noted that the flow chart 700 may include more or less number of steps that may be under the scope of the present invention. The flow chart 700 initiates at step 702. At step 704, a first frame from a plurality of frames of the video data of the video input is selected. At step 706, a macroblock by macroblock comparison of the selected first frame of the plurality of frames of the video data of the video inputs with a second frame of the plurality of frames of the video data of the video inputs to fetch a delta value is performed. The second frame is followed by the first frame in the video inputs. At step 706, the delta value is compared with a pre-determined threshold and also checking a pre-determined jerk balancing condition. At step 708, the selected second frame is skipped based on the comparison of the delta value with the pre-determined threshold and also checking the pre-determined jerk balancing condition. In an embodiment of the present invention, the macroblock by macroblock comparison of the selected first frame of the plurality of frames of the video data of the video inputs with the second frame of the plurality of frames of the video data of the video input includes calculating sum of absolute differences in pixel values between the macro blocks of the selected first frame and the selected second frame.

In an embodiment, the process steps of the flow chart 700 includes initializing the counter 608 to a pre-determined number to check maximum number of continuous skip frames from the plurality of frames of the video data of the video input. The counter 608 of the pre-determined number is continually decreased based on number of continuous skip frames from the plurality of frames of the video data of the video input. The counter 608 is re-adjusted to the pre-determined number when the counter is decreased below a minimum threshold number. The pre-determined number is set by an administrator. The pre-determined threshold and the pre-determined jerk balancing condition are based on a size of an object in motion in the video data of the video input

As stated above, the present invention has a lot of advantages over the conventional approaches. In the conventional approaches, advanced video codec (for example H264) does not encode the skip frames. In the conventional approach, the skip frames are the frames which can be formed fully with the information from one or more previous frames and future frames (Bi-directional prediction). In other words, in conventional approaches, codec tries to remove as much redundancy as possible. However, these approaches use many costly algorithms (such as diamond search) for finding the best matched macro-block and has to store lot of information. The ‘skipped frames’ (redundant information) is reproduced while decoding and playing the video. However, the frame control module 112 of the present invention does not reproduce the skipped frames while decoding and playing, thereby achieving the increase in tempo of the video. In addition, the present invention can also be used for making time constrained video. For example, the present invention has the capability to produce a 6 second video whatever the length of actual video is. This time constrained concept will help people to share videos in many video sharing platforms which have constraints on length of the video. Moreover, the present invention can be extended for different purposes. For example, instead of skipping the low motion video frames automatically, the frame control module 112 can skip all the video frames which don't have human voice audio associated with it. It will help people to make explanation video without the help of video editor.

Moreover, unlike H264 codec (and other codecs) which has a complex process of skipping the frame before encoding and is more focused on just removing the redundancy of the information, the process of the present invention is straightforward in calculation. The present invention needs the value of delta for all the MBs and comparisons are made with this same value only. In addition, in H264 codecs (and other codecs), skipped frames are marked with flags and the frames are reproduced while decoding the redundant information. In H264, the tempo of the output video is unaffected by those frames which are skipped. However, in the present invention, the skipped frames are skipped forever. In other words, the skipped frames are not reproduced even after decoding, thereby increasing the tempo of the video. Further, the present invention achieves the file size compression by throwing away the low motion frames.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A method for compressing video data of a video input, the method comprising:
selecting a first frame from a plurality of frames of said video data of said video input;
performing a macroblock by macroblock comparison of said selected first frame of said plurality of frames of said video data of said video inputs with a second frame of said plurality of frames of said video data of said video inputs to fetch a delta value, wherein said second frame is followed by said first frame in said video inputs;
comparing said delta value of said selected first frame of said plurality of frames of said video data of said video inputs with a pre-determined threshold and checking a pre-determined jerk balancing condition; and
skipping said second frame of said plurality of frames based on said comparison of said delta value with said pre-determined threshold and said pre-determined jerk balancing condition.

2. The method as recited in claim 1, wherein said macroblock by macroblock comparison of said selected first frame of said plurality of frames of said video data of said video inputs with said second frame of said plurality of frames of said video data of said video input comprises calculating sum of absolute differences in pixel values between the macro blocks of said selected first frame and said selected second frame.

3. The method as recited in claim 1, further comprising initializing a counter to a pre-determined number to check maximum number of continuous skip frames from said plurality of frames of said video data of said video input.

4. The method as recited in claim 3, wherein said counter to said pre-determined number is continually decreased based on number of continuous skip frames from said plurality of frames of said video data of said video input.

5. The method as recited in claim 4, wherein said counter is re-adjusted to said pre-determined number when said counter is decreased below a minimum threshold number.

6. The method as recited in claim 3, wherein said pre-determined number is set by an administrator.

7. The method as recited in claim 1, wherein said pre-determined threshold and said pre-determined jerk balancing condition are based on a size of an object in motion in said video data of said video input.

8. A frame control system for compressing video data of a video input, the frame control system comprising:
a selection module configured to select a first frame from a plurality of frames of said video data of said video input;
a comparison module configured for:
performing macroblock by macroblock comparison of said selected first frame of said plurality of frames of said video data of said video inputs with a second frame of said plurality of frames of said video data of said video inputs to fetch a delta value, wherein said second frame is followed by said first frame in said video inputs; and
comparing said delta value of said selected first frame of said plurality of frames of said video data of said video inputs with a pre-determined threshold and checking a pre-determined jerk balancing condition; and
a skipping module configured to skip said second frame of said plurality of frames based on said comparison of said delta value with said pre-determined threshold and said pre-determined jerk balancing condition.

9. The frame control system as recited in claim 8, wherein said comparison module is further configured to perform macroblock by macroblock comparison of said selected first frame of said plurality of frames of said video data of said video inputs with said second frame of said plurality of frames of said video data of said video input by calculating sum of absolute differences in pixel values between the macro blocks of said selected first frame and said selected second frame.

10. The frame control system as recited in claim 8, further comprising a counter to initialize a pre-determined number to check maximum number of continuous skip frames from said plurality of frames of said video data of said video input.

11. The frame control system as recited in claim 10, wherein said counter is adapted to continually decrease said pre-determined number based on number of continuous skip frames from said plurality of frames of said video data of said video input.

12. The frame control system as recited in claim 10, wherein said counter is re-adjusted to said pre-determined number when said counter is decreased below a minimum threshold number.

13. The frame control system as recited in claim 10, wherein said pre-determined number is set by an administrator.

14. A computer system for compressing video data of a video input, said computer system comprising:
one or more processors having a frame control module; and
a non-transitory memory containing instructions that, when executed by said one or more processors, causes said frame control module of said one or more processors to perform a set of steps comprising:
selecting, by a selection module of said frame control module, to select a first frame from a plurality of frames of said video data of said video input;
performing, by a comparison module of said frame control module, macroblock by macroblock comparison of said selected first frame of said plurality of frames of said video data of said video inputs with a second frame of said plurality of frames of said video data of said video inputs to fetch a delta value, wherein said second frame is followed by said first frame in said video inputs, and comparing said delta value of said selected first frame of said plurality of frames of said video data of said video inputs with a pre-determined threshold and checking a pre-determined jerk balancing condition; and
skipping, by a skipping module of said frame control module, said second frame based on said comparison of said delta value with said pre-determined threshold.

15. The computing system as recited in claim 14, wherein said skipping module of said frame control module skips said second frame said plurality of frames based on said pre-determined jerk balancing condition.

16. The computing system as recited in claim 14, wherein said comparison module is further configured to perform macroblock by macroblock comparison of said selected first frame of said plurality of frames of said video data of said video inputs with said second frame of said plurality of frames of said video data of said video input by calculating sum of absolute differences in pixel values between the macro blocks of said selected first frame and said selected second frame.

17. The computing system as recited in claim 14, wherein said frame control module further comprises a counter to initialize a pre-determined number to check maximum number of continuous skip frames from said plurality of frames of said video data of said video input.

18. The computing system as recited in claim 17, wherein said counter is adapted to continually decrease said pre-determined number based on number of continuous skip frames from said plurality of frames of said video data of said video input.

19. The computing system as recited in claim 18, wherein said counter is re-adjusted to said pre-determined number when said counter is decreased below a minimum threshold number.

20. The computing system as recited in claim 17, wherein said pre-determined number is set by an administrator.
